(19) United States
(12) Patent Application Publication
(10) Pub. No.: US 2026/0280748 A1
(43) Pub. Date: Sep. 17, 2026

(54) LINK ADAPTATION ENHANCEMENT WITH MORE COMBINATIONS OF MODULATION AND CODING SCHEMES FOR NEXT-GENERATION WLAN SYSTEMS

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 19/167,757

(22) PCT Filed: Sep. 19, 2024
(86) PCT No.: PCT/CN2024/119584

§ 371 Date: Sep. 22, 2025

Related U.S. Application Data
(60) Provisional application No. 63/584,519, filed on Sep. 22, 2023.

(51) Int. Cl. H04L 1/00; H04L 27/00

(52) U.S. Cl. CPC H04L 1/0003; H04L 1/0009; H04L 27/0008

(57) ABSTRACT

Techniques pertaining to link adaptation enhancement with more combinations of modulation and coding schemes (MCSs) for next-generation wireless local area network (WLAN) systems in wireless communications are described. An apparatus (e.g., a station (STA)) codes a plurality of bits of a packet and performs a wireless communication with the packet using a new modulation and coding scheme (MCS) not defined in an Institute of Electrical and Electronics Engineers (IEEE) 802.11be specification.

### CROSS REFERENCE TO RELATED PATENT APPLICATION

The present disclosure is part of a non-provisional patent application claiming the priority benefit of U.S. Provisional Patent Application No. 63/584,519 filed 22 Sep. 2023, the content of which herein being incorporated by reference in its entirety.

### TECHNICAL FIELD

The present disclosure is generally related to wireless communications and, more particularly, to link adaptation enhancement with more combinations of modulation and coding schemes (MCSs) for next-generation wireless local area network (WLAN) systems in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) in WLAN systems in accordance with the Institute of Electrical and Electronics Engineers (IEEE) 802.11 standards, different MCS levels are available for modulating and coding signals that are transmitted. Certain new MCS levels have been introduced to fill up the signal-to-noise ratio (SNR) and spectral efficiency gap between existing IEEE 802.11be MCS levels. However, in order to enhance link adaptation for next-generation WiFi 8 Ultra-High Reliability (UHR) systems, additional combinations of MCS levels need to be introduced. Therefore, there is a need for a solution of link adaptation enhancement with more combinations of MCSs for next-generation WLAN systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to link adaptation enhancement with more combinations of MCSs for next-generation WLAN systems in wireless communications. It is believed that implementations of various schemes proposed herein may address or otherwise alleviate the aforementioned issues.

In one aspect, a method may involve coding a plurality of bits of a packet. The method may also involve performing a wireless communication with the packet using a new modulation and coding scheme not defined in an IEEE 802.11be specification.

In another aspect, an apparatus may include a transceiver configured to communicate wirelessly and a processor coupled to the transceiver. The processor may encode a plurality of bits of a packet. The processor may also perform a wireless communication with the packet using a new modulation and coding scheme not defined in an IEEE 802.11be specification.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a diagram of an example scenario under a proposed scheme in accordance with the present disclosure.

FIG. 12 is a diagram of an example scenario under a proposed scheme in accordance with the present disclosure.

FIG. 13 is a diagram of an example scenario under a proposed scheme in accordance with the present disclosure.

FIG. 14 is a diagram of an example scenario under a proposed scheme in accordance with the present disclosure.

FIG. 15 is a diagram of an example scenario under a proposed scheme in accordance with the present disclosure.

FIG. 16 is a diagram of an example scenario under a proposed scheme in accordance with the present disclosure.

FIG. 17 is a diagram of an example scenario under a proposed scheme in accordance with the present disclosure.

FIG. 18 is a diagram of an example scenario under a proposed scheme in accordance with the present disclosure.

FIG. 19 is a diagram of an example scenario under a proposed scheme in accordance with the present disclosure.

FIG. 20 is a diagram of an example scenario under a proposed scheme in accordance with the present disclosure.

FIG. 21 is a diagram of an example design under a proposed scheme in accordance with the present disclosure.

FIG. 22 is a block diagram of an example communication system in accordance with an implementation of the present disclosure.

FIG. 23 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to link adaptation enhancement with more combinations of MCSs for next-generation WLAN systems in wireless communications. According to the present disclosure, a number of possible solutions may be implemented separately or jointly. That is, although these possible solutions may be described below separately, two or more of these possible solutions may be implemented in one combination or another.

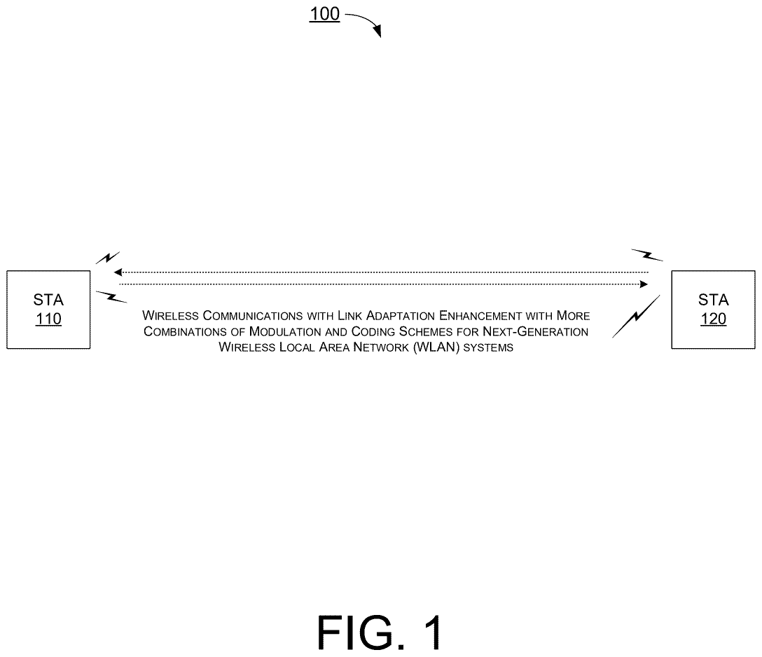

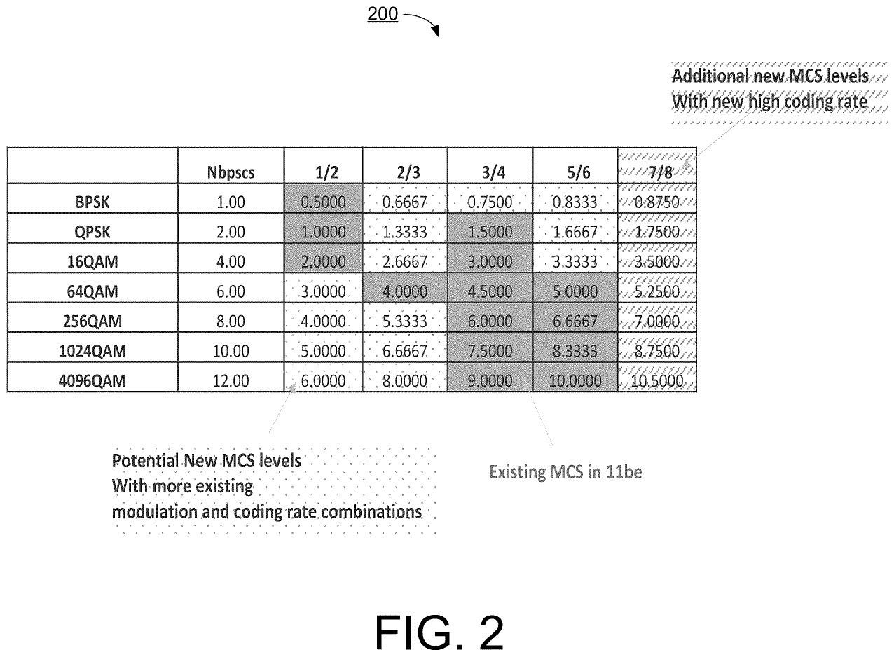

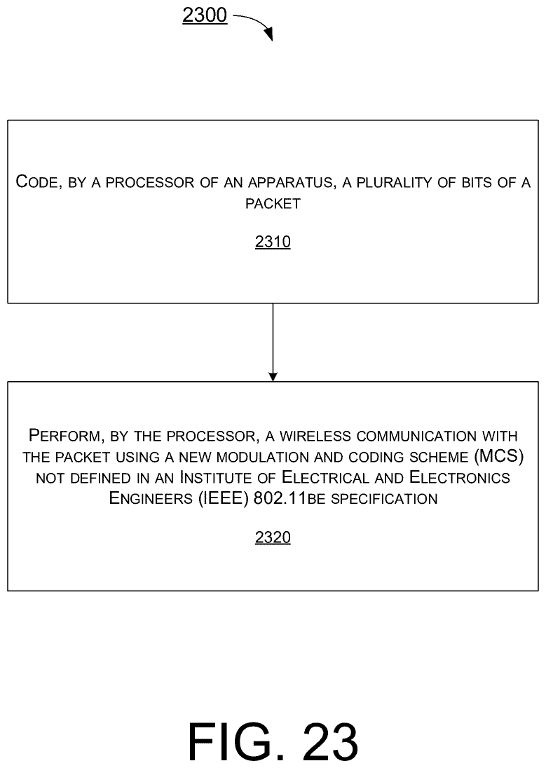

FIG. 1 illustrates an example network environment 100 in which various solutions and schemes in accordance with the present disclosure may be implemented. FIG. 2~FIG. 23 illustrate examples of implementation of various proposed schemes in network environment 100 in accordance with the present disclosure. The following description of various proposed schemes is provided with reference to FIG. 1~FIG. 23.

Referring to part (A) of FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the link adaptation enhancement with more combinations of MCSs for next-generation WLAN systems in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

To propose additional combinations of MCSs to enhance link adaptation for next-generation WLAN systems, such as Wi-Fi 8 UHR systems and beyond, simulations are performed to evaluate physical-layer (PHY) rate performance for link adaptation enhancement with new MCS definitions. Specifically, PHY rate performance simulations are performed with binary phase-shift keying (BPSK), quadrature phase-shift keying (QPSK) and various quadrature amplitude modulation (QAM) levels, such as 16 QAM, 64 QAM, 256 QAM, 1024 QAM and 4096 QAM, with different coding rates R such as R=½, ⅔, ¾, ⅚ and ⅞. Moreover, performance simulation settings may include various aspects including bandwidth (BW), channel, number of spatial streams (Nss), transmitter/receiver (Tx/Rx) configuration, packet length, error correction code, MCS level, and PHY rate. The bandwidths simulated include 20 MHz (herein interchangeably denoted as “20 BW”), 40 MHz (herein interchangeably denoted as “40 BW”), 80 MHz (herein interchangeably denoted as “80 BW”) and 160 MHz (herein interchangeably denoted as “160 BW”). The channels simulated include additive white Gaussian noise (AWGN), model D non-line-of-sight (D-NLOS), and model B line-of-sight (B-LOS). The Nss simulated include one spatial stream (1ss) and two spatial streams (2ss). The packet length simulated is 1458 bytes with an ideal channel. The error correction code simulated is low-density parity-check (LDPC) error correction code. The MCS levels simulated include existing IEEE 802.11be MCS levels and 20 new MCS levels. The PHY rate simulation is performed with the assumption of a 3.2 μs guard interval (GI) and a sensitivity at packet error rate (PER) of 10%.

FIG. 2 illustrates an example scenario 200 of a combination of modulation and coding rates for potential new MCS levels under a proposed scheme in accordance with the present disclosure. Referring to FIG. 2, the table shows various MCS levels corresponding to different numbers of bits per subcarrier per stream (N_{bpscs}), including existing MCS levels in IEEE 802.11be, potential new MCS levels with more existing modulation and coding rate combinations, and additional new MCS levels with a new high coding rate of ⅞.

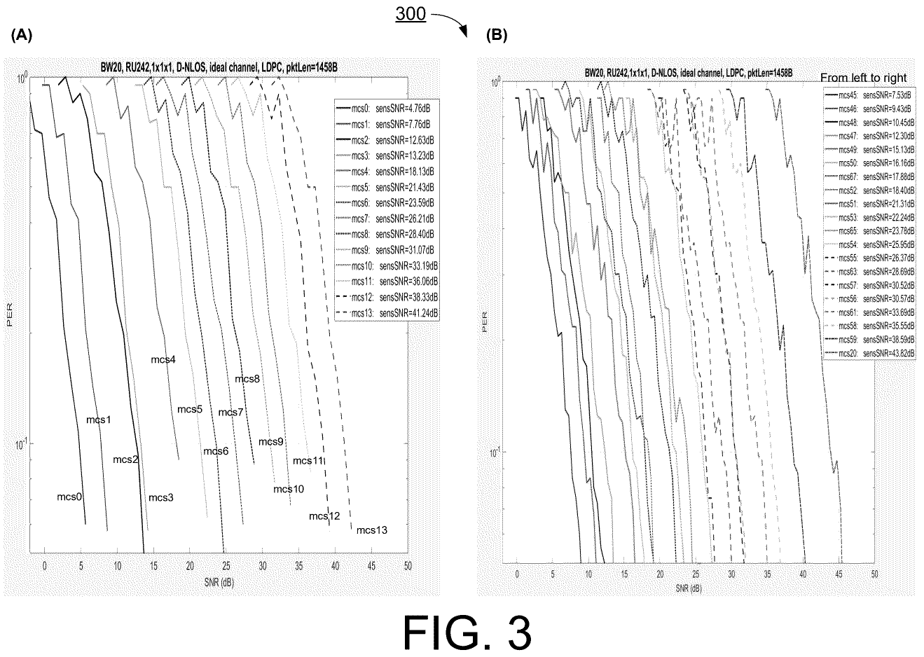

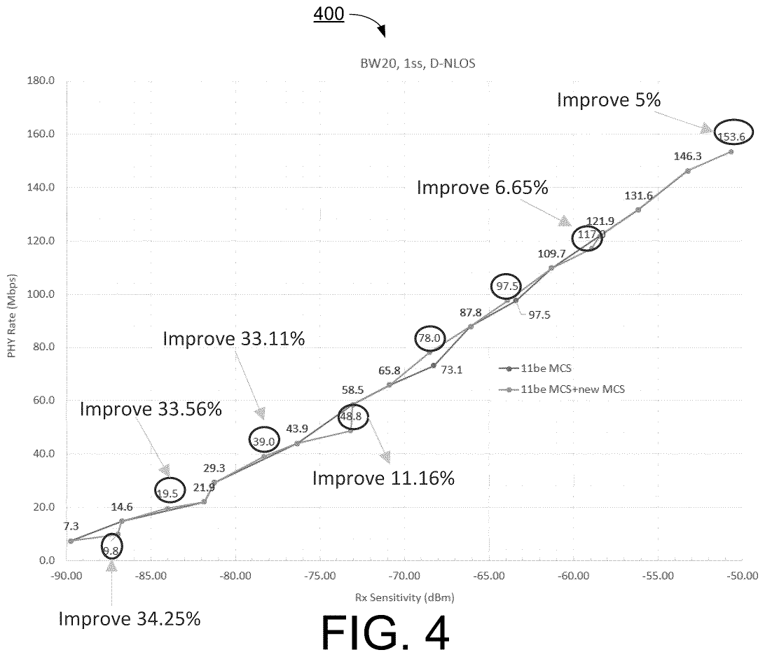

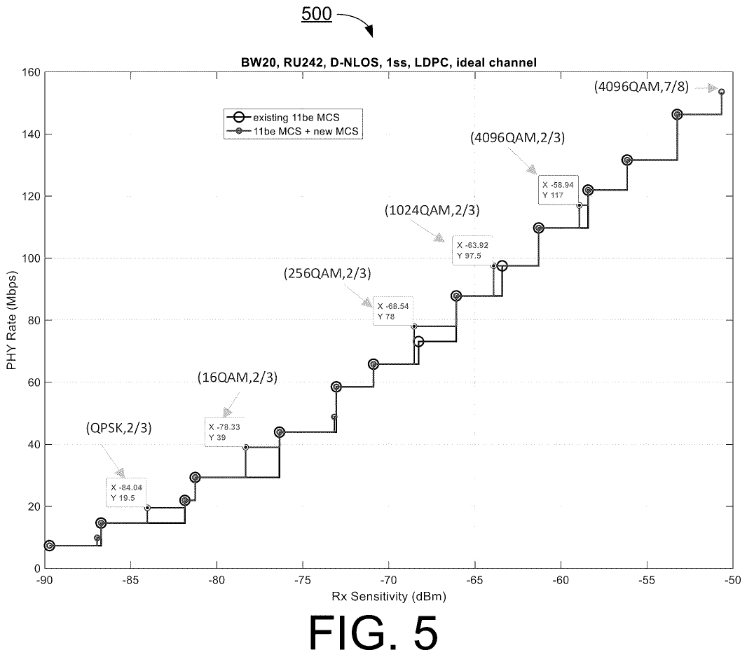

FIG. 3 illustrates an example scenario 300 of a comparison of simulation results between IEEE 802.11be MCS levels and new MCS levels with BW20, 1ss and D-NLOS. Part (A) of FIG. 3 shows simulation results for existing MCS levels in IEEE 802.11be. Part (B) of FIG. 3 shows simulation results for new MCS levels under the proposed scheme. FIG. 4 illustrates an example scenario 400 of a comparison of simulation results between IEEE 802.11be MCS levels and new MCS levels with BW20, 1ss and D-NLOS. FIG. 5 illustrates an example scenario 500 of a comparison of simulation results between IEEE 802.11be MCS levels and new MCS levels with BW20, 1ss and D-NLOS.

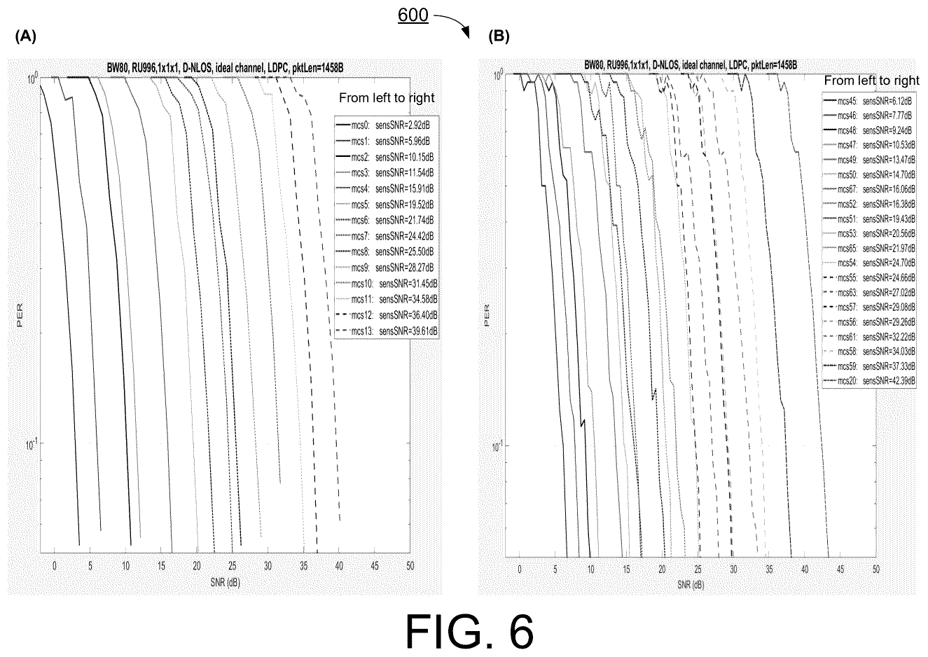

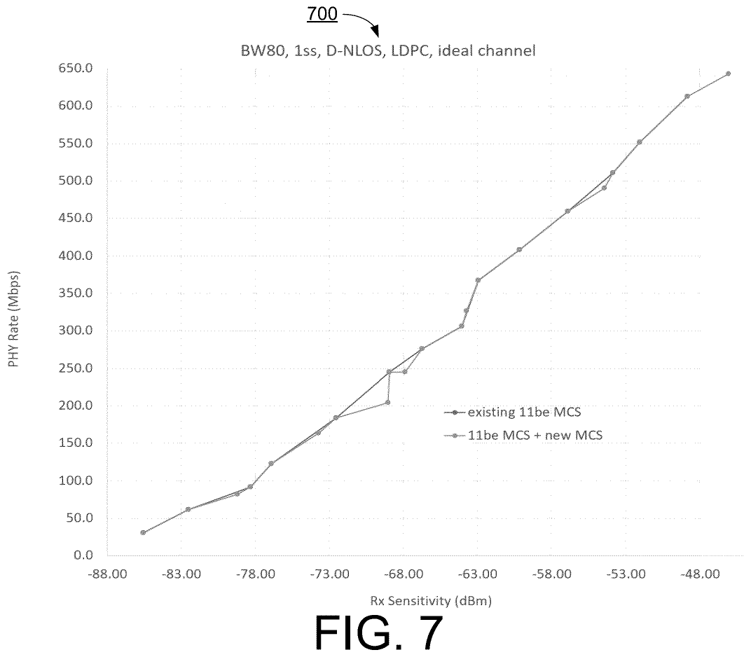

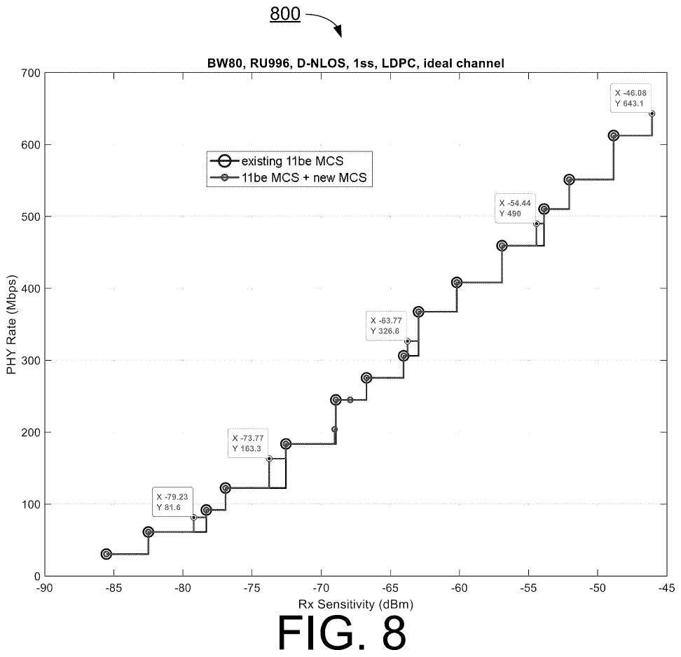

FIG. 6 illustrates an example scenario 600 of a comparison of simulation results between IEEE 802.11be MCS levels and new MCS levels with BW80, 1ss and D-NLOS. Part (A) of FIG. 6 shows simulation results for existing MCS levels in IEEE 802.11be. Part (B) of FIG. 6 shows simulation results for new MCS levels under the proposed scheme. FIG. 7 illustrates an example scenario 700 of a comparison of simulation results between IEEE 802.11be MCS levels and new MCS levels with BW80, 1ss and D-NLOS. FIG. 8 illustrates an example scenario 800 of a comparison of simulation results between IEEE 802.11be MCS levels and new MCS levels with BW80, 1ss and D-NLOS.

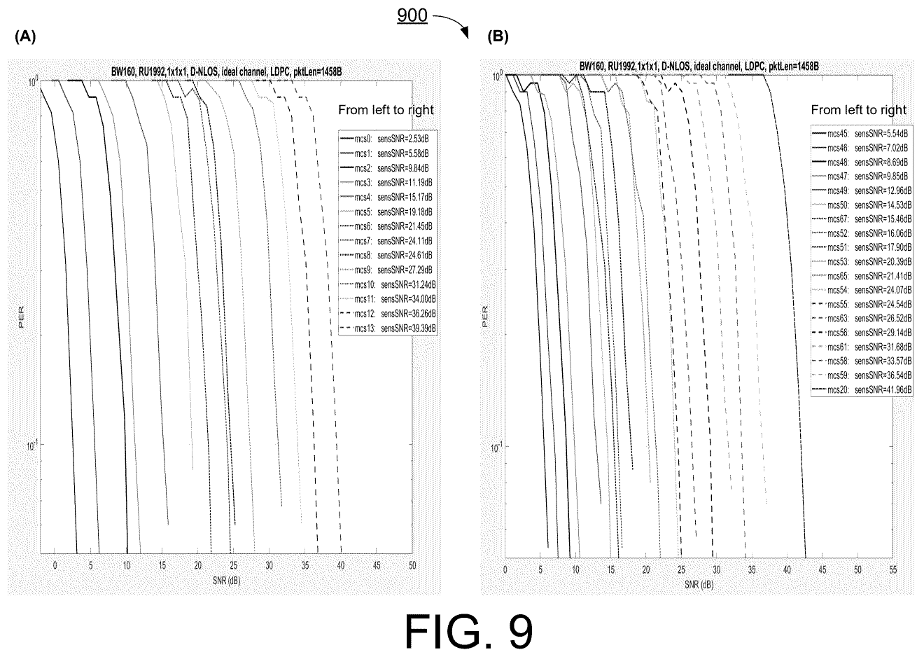

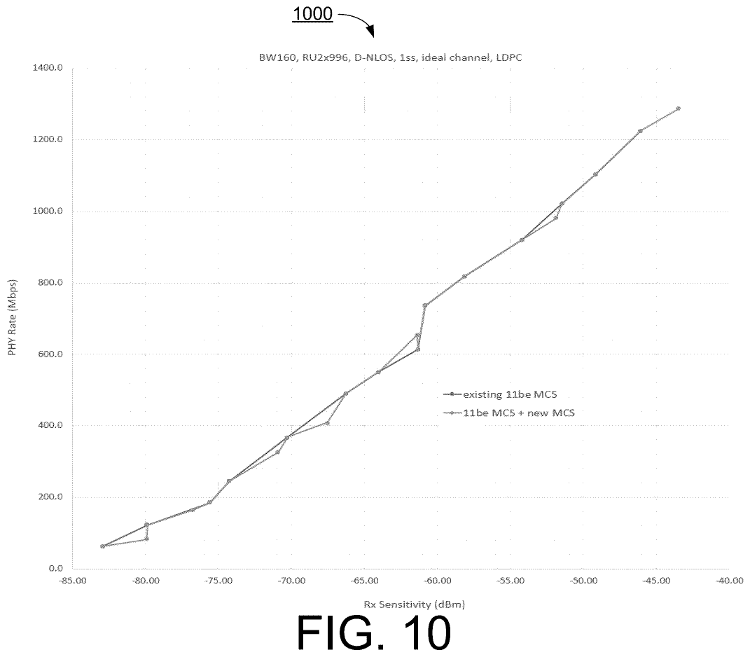

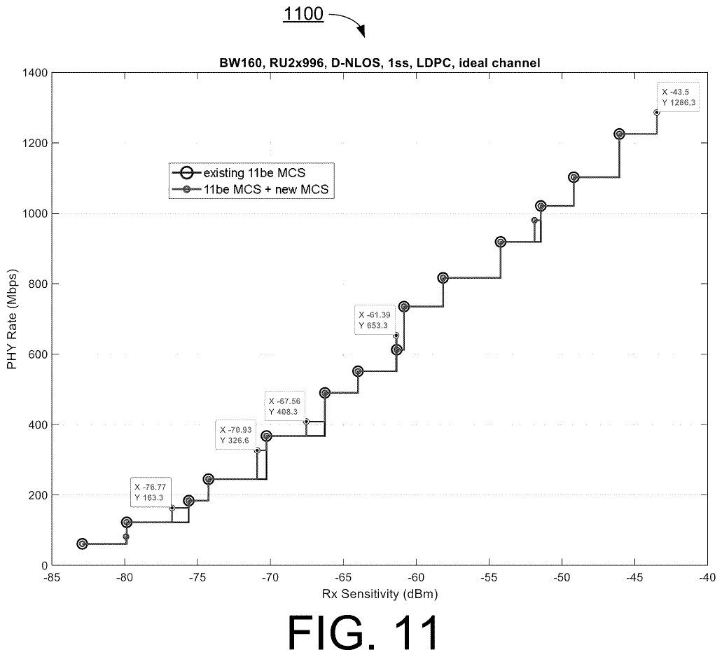

FIG. 9 illustrates an example scenario 900 of a comparison of simulation results between IEEE 802.11be MCS levels and new MCS levels with BW160, 1ss and D-NLOS. Part (A) of FIG. 9 shows simulation results for existing MCS levels in IEEE 802.11be. Part (B) of FIG. 9 shows simulation results for new MCS levels under the proposed scheme. FIG. 10 illustrates an example scenario 1000 of a comparison of simulation results between IEEE 802.11be MCS levels and new MCS levels with BW160, 1ss and D-NLOS. FIG. 11 illustrates an example scenario 1100 of a comparison of simulation results between IEEE 802.11be MCS levels and new MCS levels with BW160, 1ss and D-NLOS.

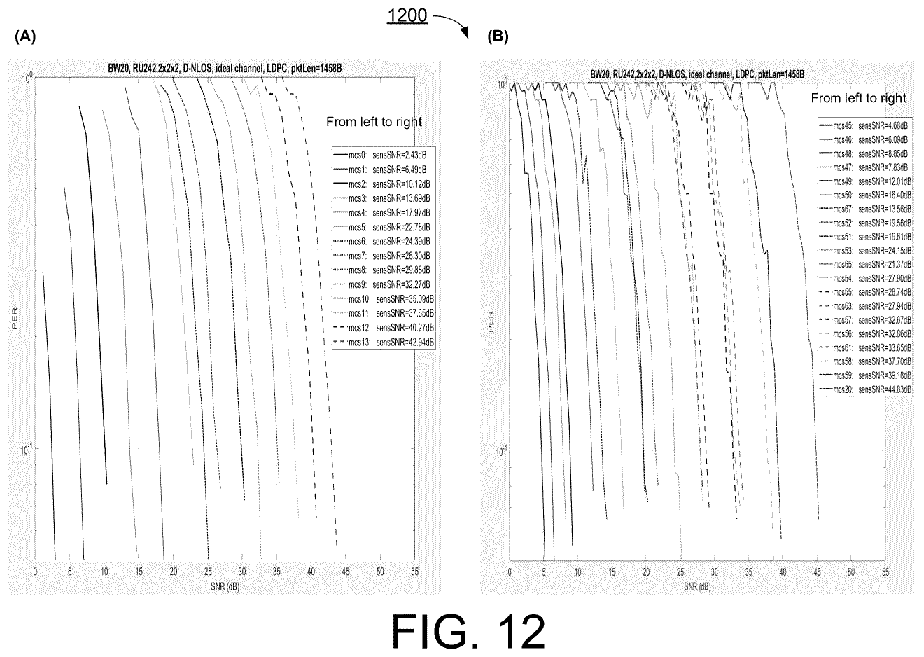

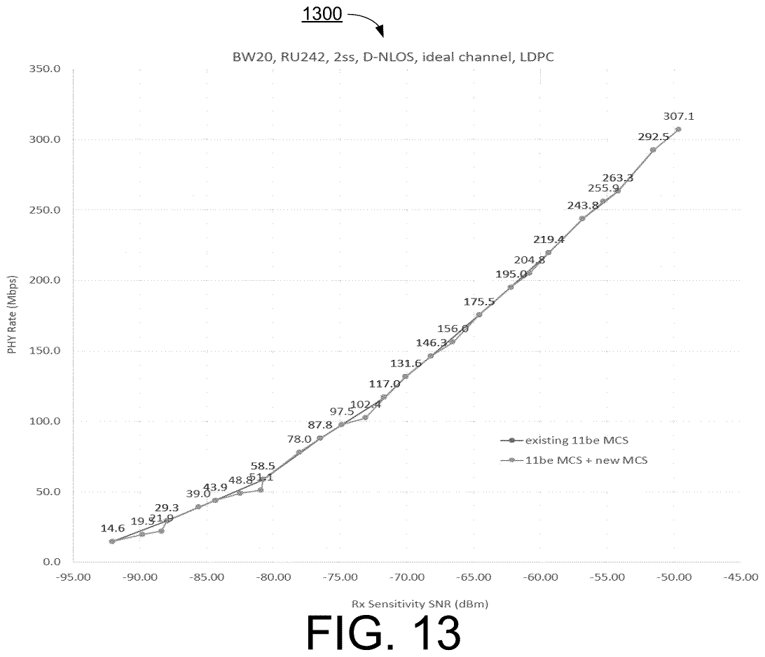

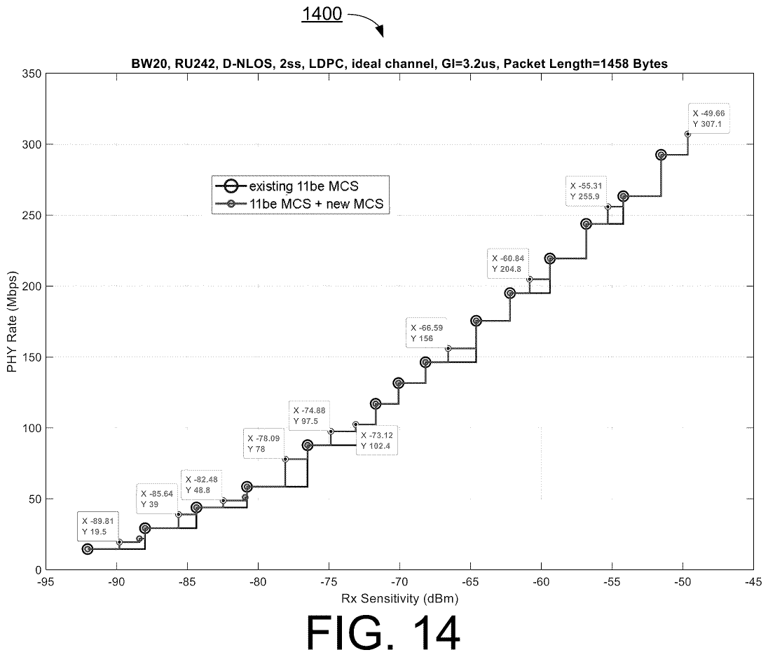

FIG. 12 illustrates an example scenario 1200 of a comparison of simulation results between IEEE 802.11be MCS levels and new MCS levels with BW20, 2ss and D-NLOS. Part (A) of FIG. 12 shows simulation results for existing MCS levels in IEEE 802.11be. Part (B) of FIG. 12 shows simulation results for new MCS levels under the proposed scheme. FIG. 13 illustrates an example scenario 1300 of a comparison of simulation results between IEEE 802.11be MCS levels and new MCS levels with BW20, 2ss and D-NLOS. FIG. 14 illustrates an example scenario 1400 of a comparison of simulation results between IEEE 802.11be MCS levels and new MCS levels with BW20, 2ss and D-NLOS.

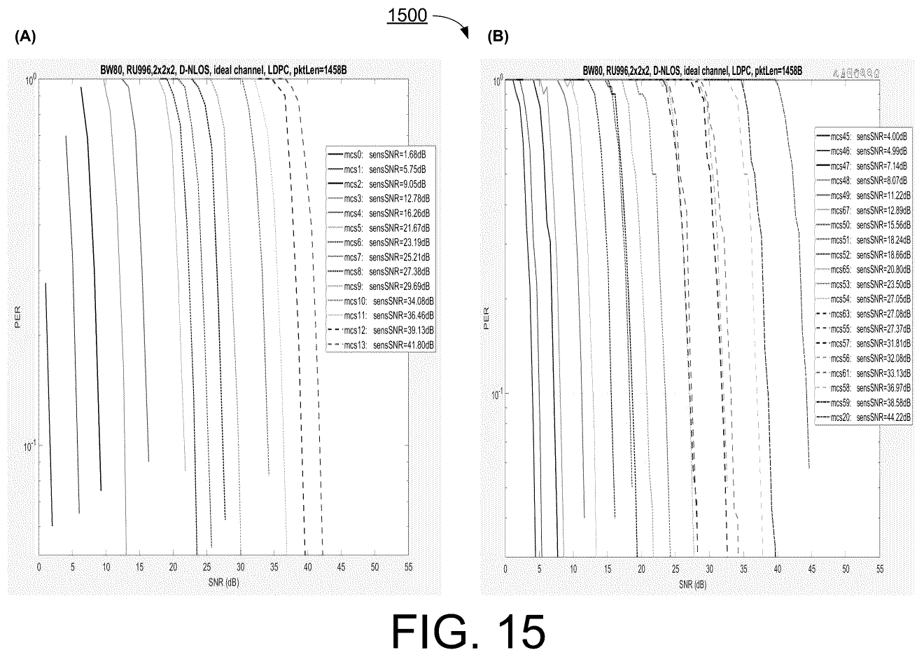

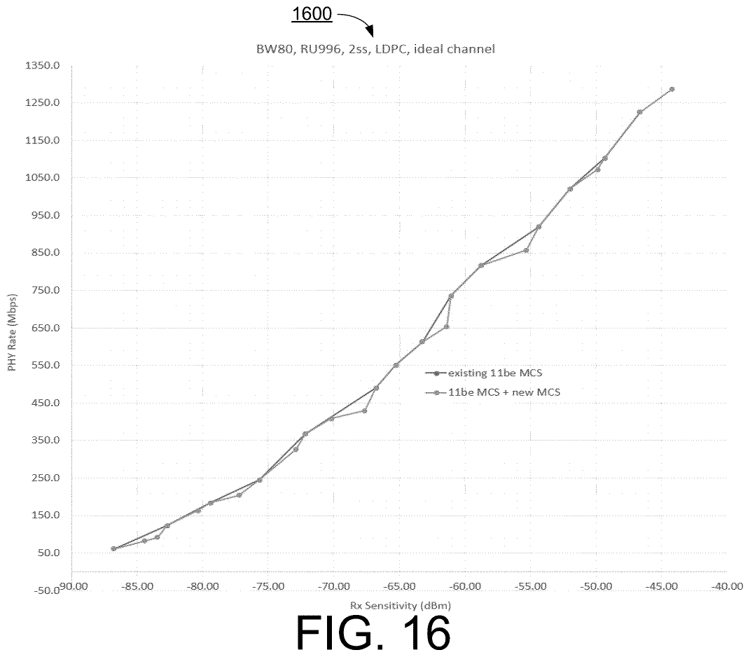

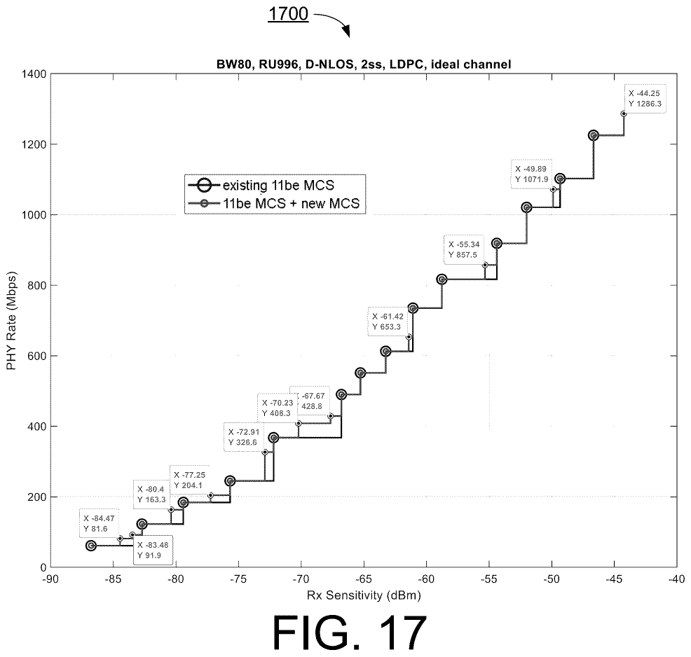

FIG. 15 illustrates an example scenario 1500 of a comparison of simulation results between IEEE 802.11be MCS levels and new MCS levels with BW80, 2ss and D-NLOS. Part (A) of FIG. 15 shows simulation results for existing MCS levels in IEEE 802.11be. Part (B) of FIG. 15 shows simulation results for new MCS levels under the proposed scheme. FIG. 16 illustrates an example scenario 1600 of a comparison of simulation results between IEEE 802.11be MCS levels and new MCS levels with BW80, 2ss and D-NLOS. FIG. 17 illustrates an example scenario 1700 of a comparison of simulation results between IEEE 802.11be MCS levels and new MCS levels with BW80, 2ss and D-NLOS.

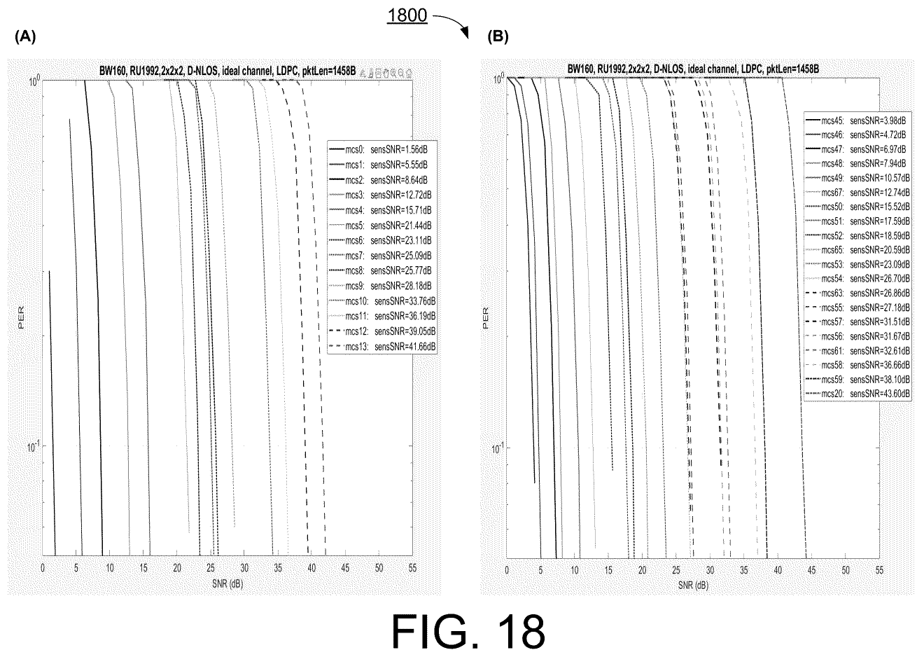

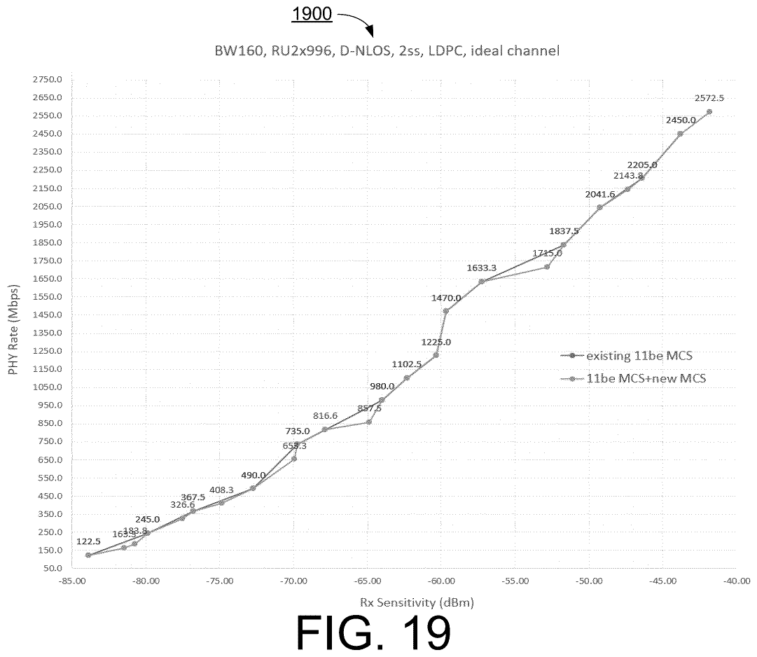

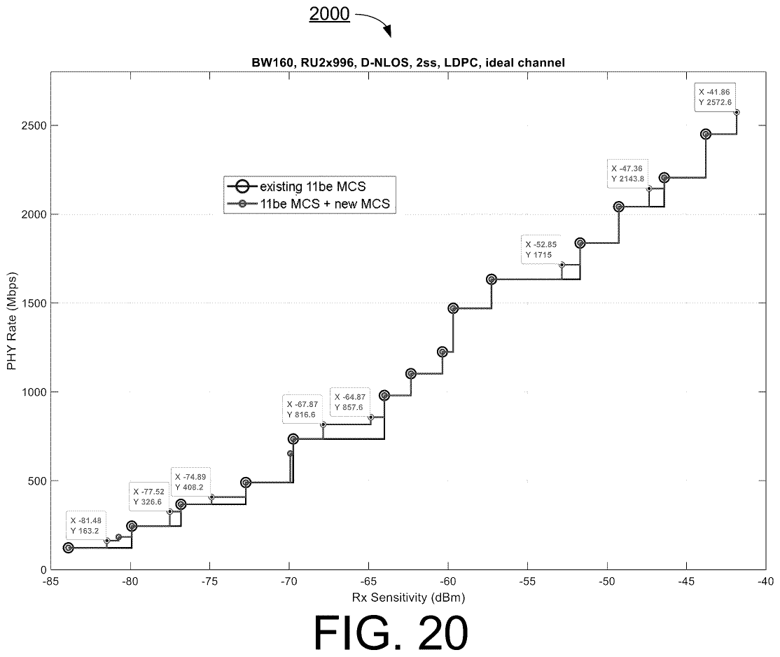

FIG. 18 illustrates an example scenario 1800 of a comparison of simulation results between IEEE 802.11be MCS levels and new MCS levels with BW160, 2ss and D-NLOS. Part (A) of FIG. 18 shows simulation results for existing MCS levels in IEEE 802.11be. Part (B) of FIG. 18 shows simulation results for new MCS levels under the proposed scheme. FIG. 19 illustrates an example scenario 1900 of a comparison of simulation results between IEEE 802.11be MCS levels and new MCS levels with BW160, 2ss and D-NLOS. FIG. 20 illustrates an example scenario 2000 of a comparison of simulation results between IEEE 802.11be MCS levels and new MCS levels with BW160, 2ss and D-NLOS.

In Wi-Fi 7 Extremely-High-Throughput (EHT) systems, there are 16 MCS levels in which: (1) the coding rate R=⅔ is only used with 64 QAM for MCS5; (2) the coding rate R=⅚ is only used for modulation order higher than 16 QAM; and (3) the highest coding rate is ⅚. Under a proposed scheme in accordance with the present disclosure, according to the simulation results, more combinations of modulation and coding schemes may be introduced to greatly improve system throughput. In some cases, it is believed that the system throughput may be improved by >30%. Under the proposed scheme, for the existing coding rate of R=⅔, other than 64 QAM, R=⅔ may also be used for modulations with BPSK, QPSK, 16 QAM, 256 QAM, 1024 QAM and 4096 QAM. Moreover, for the existing coding rate of R=⅚, other than higher QAM, R=⅚ may also be used for modulations with QPSK and 16 QAM. Furthermore, a new higher coding rate of R=⅞ may be introduced, and this new coding rate of R=⅞ may be used with 16 QAM, 64 QAM, 256 QAM, 1024 QAM and 4096 QAM to improve the system throughput.

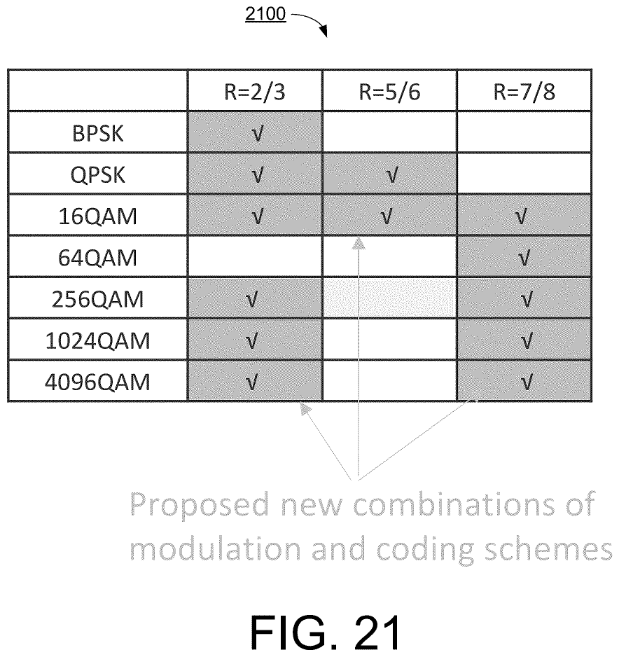

FIG. 21 illustrates an example design 2100 of new combinations of modulation and coding schemes under a proposed scheme in accordance with the present disclosure. Referring to FIG. 21, the table shows that BPSK may be utilized with R=⅔; QPSK may be utilized with R=⅔ and ⅚; 16 QAM may be utilized with R=⅔, ⅚ and ⅞; 64 QAM may be utilized with R=⅞; 256 QAM may be utilized with R=⅔ and ⅞; 1024 QAM may be utilized with R=⅔ and ⅞; and 4096 QAM may be utilized with R=⅔ and ⅞.

### Illustrative Implementations

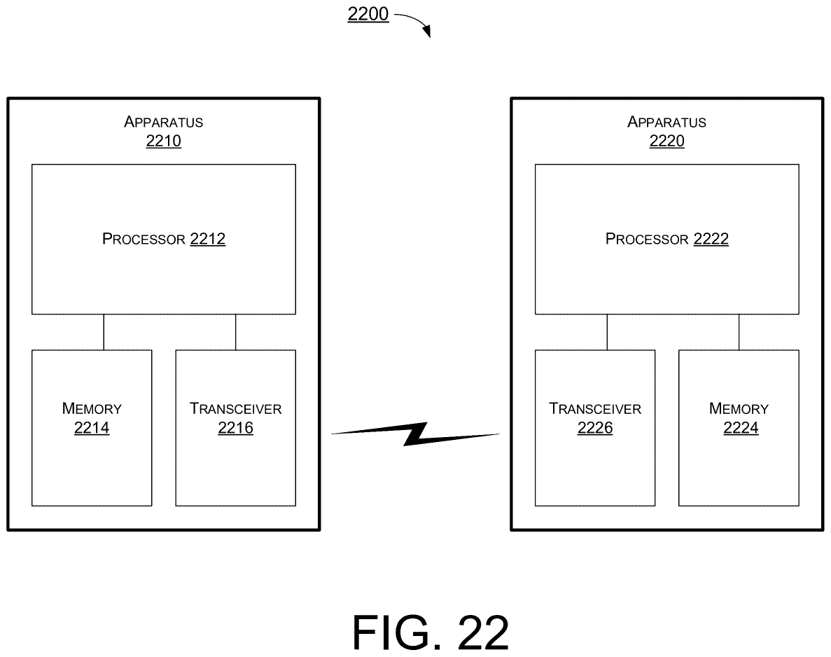

FIG. 22 illustrates an example system 2200 having at least an example apparatus 2210 and an example apparatus 2220 in accordance with an implementation of the present disclosure. Each of apparatus 2210 and apparatus 2220 may perform various functions to implement schemes, techniques, processes and methods described herein pertaining to link adaptation enhancement with more combinations of MCSs for next-generation WLAN systems in wireless communications including the various schemes described above with respect to various proposed designs, concepts, schemes, systems and methods described above as well as processes described below. For instance, apparatus 2210 may be implemented in STA 110 and apparatus 2220 may be implemented in STA 120, or vice versa.

Each of apparatus 2210 and apparatus 2220 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 2210 and apparatus 2220 may be implemented in a smartphone, a smart watch, a personal digital assistant, a digital camera, or a computing equipment such as a tablet computer, a laptop computer or a notebook computer. Each of apparatus 2210 and apparatus 2220 may also be a part of a machine type apparatus, which may be an IoT apparatus such as an immobile or a stationary apparatus, a home apparatus, a wire communication apparatus or a computing apparatus. For instance, each of apparatus 2210 and apparatus 2220 may be implemented in a smart thermostat, a smart fridge, a smart door lock, a wireless speaker or a home control center. When implemented in or as a network apparatus, apparatus 2210 and/or apparatus 2220 may be implemented in a network node, such as an AP in a WLAN.

In some implementations, each of apparatus 2210 and apparatus 2220 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 2210 and apparatus 2220 may be implemented in or as a STA or an AP. Each of apparatus 2210 and apparatus 2220 may include at least some of those components shown in FIG. 22 such as a processor 2212 and a processor 2222, respectively, for example. Each of apparatus 2210 and apparatus 2220 may further include one or more other components not pertinent to the proposed scheme of the present disclosure (e.g., internal power supply, display device and/or user interface device), and, thus, such component(s) of apparatus 2210 and apparatus 2220 are neither shown in FIG. 22 nor described below in the interest of simplicity and brevity.

In one aspect, each of processor 2212 and processor 2222 may be implemented in the form of one or more single-core processors, one or more multi-core processors, one or more RISC processors or one or more CISC processors. That is, even though a singular term “a processor” is used herein to refer to processor 2212 and processor 2222, each of processor 2212 and processor 2222 may include multiple processors in some implementations and a single processor in other implementations in accordance with the present disclosure. In another aspect, each of processor 2212 and processor 2222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2212 and processor 2222 is a special-purpose machine specifically designed, arranged and configured to perform specific tasks including those pertaining to link adaptation enhancement with more combinations of MCSs for next-generation WLAN systems in wireless communications in accordance with various implementations of the present disclosure.

In some implementations, apparatus 2210 may also include a transceiver 2216 coupled to processor 2212. Transceiver 2216 may include a transmitter capable of wirelessly transmitting and a receiver capable of wirelessly receiving data. In some implementations, apparatus 2220 may also include a transceiver 2226 coupled to processor 2222. Transceiver 2226 may include a transmitter capable of wirelessly transmitting and a receiver capable of wirelessly receiving data. It is noteworthy that, although transceiver 2216 and transceiver 2226 are illustrated as being external to and separate from processor 2212 and processor 2222, respectively, in some implementations, transceiver 2216 may be an integral part of processor 2212 as a system on chip (SoC), and transceiver 2226 may be an integral part of processor 2222 as a SoC.

In some implementations, apparatus 2210 may further include a memory 2214 coupled to processor 2212 and capable of being accessed by processor 2212 and storing data therein. In some implementations, apparatus 2220 may further include a memory 2224 coupled to processor 2222 and capable of being accessed by processor 2222 and storing data therein. Each of memory 2214 and memory 2224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 2214 and memory 2224 may include a type of read-only memory (ROM) such as mask ROM, programmable ROM (PROM), erasable programmable ROM (EPROM) and/or electrically erasable programmable ROM (EEPROM). Alternatively, or additionally, each of memory 2214 and memory 2224 may include a type of non-volatile random-access memory (NVRAM) such as flash memory, solid-state memory, ferroelectric RAM (FeRAM), magnetoresistive RAM (MRAM) and/or phase-change memory.

Each of apparatus 2210 and apparatus 2220 may be a communication entity capable of communicating with each other using various proposed schemes in accordance with the present disclosure. For illustrative purposes and without limitation, a description of capabilities of apparatus 2210, as STA 110, and apparatus 2220, as STA 120, is provided below in the context of example process 2300. It is noteworthy that, although a detailed description of capabilities, functionalities and/or technical features of apparatus 2220 is provided below, the same may be applied to apparatus 2210 although a detailed description thereof is not provided solely in the interest of brevity. It is also noteworthy that, although the example implementations described below are provided in the context of WLAN, the same may be implemented in other types of networks.

### Illustrative Processes

FIG. 23 illustrates an example process 2300 in accordance with an implementation of the present disclosure. Process 2300 may represent an aspect of implementing various proposed designs, concepts, schemes, systems and methods described above. More specifically, process 2300 may represent an aspect of the proposed concepts and schemes pertaining to link adaptation enhancement with more combinations of MCSs for next-generation WLAN systems in wireless communications in accordance with the present disclosure. Process 2300 may include one or more operations, actions, or functions as illustrated by one or more of blocks 2310 and 2320. Although illustrated as discrete blocks, various blocks of process 2300 may be divided into additional blocks, combined into fewer blocks, or eliminated, depending on the desired implementation. Moreover, the blocks/sub-blocks of process 2300 may be executed in the order shown in FIG. 23 or, alternatively, in a different order. Furthermore, one or more of the blocks/sub-blocks of process 2300 may be executed repeatedly or iteratively. Process 2300 may be implemented by or in apparatus 2210 and apparatus 2220 as well as any variations thereof. Solely for illustrative purposes and without limiting the scope, process 2300 is described below in the context of apparatus 2210 implemented in or as STA 110 functioning as a non-AP STA or an AP STA and apparatus 2220 implemented in or as STA 120 functioning as an AP STA or a non-AP STA of a wireless network such as a WLAN in network environment 100 in accordance with one or more of IEEE 802.11 standards. Process 2300 may begin at block 2310.

At 2310, process 2300 may involve processor 2212 of apparatus 2210 coding a plurality of bits of a packet. Process 2300 may proceed from 2310 to 2320.

At 2320, process 2300 may involve processor 2212 performing, via transceiver 2216, a wireless communication (e.g., transmission to apparatus 2220) with the packet using a new MCS not defined in an IEEE 802.11be specification.

In some implementations, in performing the wireless communication using the new MCS, process 2300 may involve processor 2212 performing the wireless communication with an existing coding rate R=⅔ and an existing modulation of BPSK, QPSK, 16 QAM, 256 QAM, 1024 QAM or 4096 QAM.

In some implementations, in performing the wireless communication using the new MCS, process 2300 may involve processor 2212 performing the wireless communication with a coding rate R=⅚ and a modulation of QPSK or 16 QAM.

In some implementations, in performing the wireless communication using the new MCS, process 2300 may involve processor 2212 performing the wireless communication with a new coding rate R=⅞ and an existing modulation of 16 QAM, 64 QAM, 256 QAM, 1024 QAM or 4096 QAM.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
coding, by a processor of an apparatus, a plurality of bits of a packet; and
performing, by the processor, a wireless communication with the packet using a new modulation and coding scheme (MCS) not defined in an Institute of Electrical and Electronics Engineers (IEEE) 802.11be specification.

2. The method of claim 1, wherein the performing of the wireless communication using the new MCS comprises performing the wireless communication with an existing coding rate R=⅔ and an existing modulation of binary phase-shift keying (BPSK).

3. The method of claim 1, wherein the performing of the wireless communication using the new MCS comprises performing the wireless communication with an existing coding rate R=⅔ and an existing modulation of quadrature phase-shift keying (QPSK).

4. The method of claim 1, wherein the performing of the wireless communication using the new MCS comprises performing the wireless communication with an existing coding rate R=⅔ and an existing modulation of 16 quadrature amplitude modulation (16 QAM).

5. The method of claim 1, wherein the performing of the wireless communication using the new MCS comprises performing the wireless communication with an existing coding rate R=⅔ and an existing modulation of 256 quadrature amplitude modulation (256 QAM).

6. The method of claim 1, wherein the performing of the wireless communication using the new MCS comprises performing the wireless communication with an existing coding rate R=⅔ and an existing modulation of 1024 quadrature amplitude modulation (1024 QAM).

7. The method of claim 1, wherein the performing of the wireless communication using the new MCS comprises performing the wireless communication with an existing coding rate R=⅔ and an existing modulation of 4096 quadrature amplitude modulation (4096 QAM).

8. The method of claim 1, wherein the performing of the wireless communication using the new MCS comprises performing the wireless communication with an existing coding rate R=⅚ and an existing modulation of quadrature phase-shift keying (QPSK).

9. The method of claim 1, wherein the performing of the wireless communication using the new MCS comprises performing the wireless communication with an existing coding rate R=⅚ and an existing modulation of 16 quadrature amplitude modulation (16 QAM).

10. The method of claim 1, wherein the performing of the wireless communication using the new MCS comprises performing the wireless communication with a new coding rate R=⅞ and an existing modulation of 16 quadrature amplitude modulation (16 QAM).

11. The method of claim 1, wherein the performing of the wireless communication using the new MCS comprises performing the wireless communication with a new coding rate R=⅞ and an existing modulation of 64 quadrature amplitude modulation (64 QAM).

12. The method of claim 1, wherein the performing of the wireless communication using the new MCS comprises performing the wireless communication with a new coding rate R=⅞ and an existing modulation of 256 quadrature amplitude modulation (256 QAM).

13. The method of claim 1, wherein the performing of the wireless communication using the new MCS comprises performing the wireless communication with a new coding rate R=⅞ and an existing modulation of 1024 quadrature amplitude modulation (1024 QAM).

14. The method of claim 1, wherein the performing of the wireless communication using the new MCS comprises performing the wireless communication with a new coding rate R=⅞ and an existing modulation of 4096 quadrature amplitude modulation (4096 QAM).

15. An apparatus, comprising:
a transceiver configured to communicate wirelessly; and
a processor coupled to the transceiver and configured to perform operations comprising:
coding a plurality of bits of a packet; and
performing, via the transceiver, a wireless communication with the packet using a new modulation and coding scheme (MCS) not defined in an Institute of Electrical and Electronics Engineers (IEEE) 802.11be specification.

16. The apparatus of claim 15, wherein the performing of the wireless communication using the new MCS comprises performing the wireless communication with an existing coding rate R=⅔ and an existing modulation of binary phase-shift keying (BPSK), quadrature phase-shift keying (QPSK), 16 quadrature amplitude modulation (16 QAM), 256 quadrature amplitude modulation (256 QAM), 1024 quadrature amplitude modulation (1024 QAM) or 4096 quadrature amplitude modulation (4096 QAM).

17. The apparatus of claim 15, wherein the performing of the wireless communication using the new MCS comprises performing the wireless communication with an existing coding rate R=⅚ and an existing modulation of quadrature phase-shift keying (QPSK) or 16 quadrature amplitude modulation (16 QAM).

18. The apparatus of claim 15, wherein the performing of the wireless communication using the new MCS comprises performing the wireless communication with a new coding rate R=⅞ and an existing modulation of 16 quadrature amplitude modulation (16 QAM), 64 quadrature amplitude modulation (64 QAM), 256 quadrature amplitude modulation (256 QAM), 1024 quadrature amplitude modulation (1024 QAM) or 4096 quadrature amplitude modulation (4096 QAM).
